(19) United States
(12) Patent Application Publication
(10) Pub. No.: US 2020/0033680 A1
(43) Pub. Date: Jan. 30, 2020

(54) LIQUID CRYSTAL DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventor: Yanxi YE, Shenzhen (CN)

(21) Appl. No.: 16/234,411

(22) Filed: Dec. 27, 2018

Related U.S. Application Data
(63) Continuation of application No. PCT/CN2018/105639, filed on Sep. 14, 2018.

(30) Foreign Application Priority Data
Jul. 25, 2018 (CN) 201810824035.5

(51) Int. Cl. G02F 1/1343; G02F 1/1362

(52) U.S. Cl. CPC G02F 1/134309; G02F 1/136286; G02F 1/136209; G02F 2201/123; G02F 2201/128; G02F 2001/136218; G02F 2201/122; G02F 1/13439

(57) ABSTRACT

A liquid crystal display panel is provided. The panel includes multiple scanning lines and multiple data lines on an array substrate, wherein a top of the data lines is covered with a light-shading electrode line; wherein the multiple scanning lines and the multiple data lines are intersected to define multiple pixel regions, and each pixel region is provided with a pixel electrode; and wherein the pixel electrode is provided with a notch at a corner adjacent to the light-shielding electrode line. The invention can improve the contrast of the panel, and the light leakage in the dark state will not occur at the corners of the pixel electrode.

### CROSS-REFERENCE TO RELATED APPLICATION

This application is a continuing application of PCT Patent Application No. PCT/CN2018/105639, entitled “LIQUID CRYSTAL DISPLAY PANEL”, filed on Sep. 14, 2018, which claims priority to China Patent Application No. 201810824035.5 filed on Jul. 25, 2018, both of which are hereby incorporated in its entireties by reference.

### FIELD OF THE INVENTION

The present invention relates to a display technology field, and more particularly to a liquid crystal display panel.

### BACKGROUND OF THE INVENTION

HVA (also known as PSVA, which is the stable vertical alignment of the polymer, that is, adding a chemical monomer to the liquid crystal, the chemical monomer is polymerized by ultraviolet light to form a polymer bump during the alignment process, and the polymer bump is used for fixing The liquid crystal to form a pre-tilt angle) mode is widely used in the large-sized LCD (Liquid Crystal Display) display industry. In the HVA mode display device, the pixel electrode is generally made of indium tin oxide (ITO) material, and the light-shielding material of the pixel is generally a black matrix (BM).

In the pixel arrangement of a normal HVA mode display, a black matrix can be used to shield the scanning lines and the data line regions. The black matrix is generally prepared on a side of the color filter substrate. In the curved display panel, the color matrix substrate side and the array substrate side have different curvatures, and the black matrix on the side of the color filter substrate is displaced when the data line is shielded, which leads to a light leakage. Accordingly, there is the emergence of DBS (data BM less) technology. The DBS technique shrinks the black matrix on the data line and uses the ITO common electrode instead of the black matrix next to the pixel electrode. Because the ITO common electrode has no pressure difference between the common electrode on the side of the array substrate and the common electrode on the side of the color filter substrate, the liquid crystal does not rotate here, and the fact that the liquid crystal does not rotate means that the region is in a dark state. Therefore, in the DBS technology, the ITO common electrode can replace the black matrix and has a light-shading function.

The pixel structure of a conventional DBS design is as shown in FIG. 1. The ITO common electrode 12′ and the pixel electrode 11′ share a same layer of ITO. At the four corners of the pixel electrode 11′, because on the periphery of the pixel electrode 11′, the electric field directions of the lateral ITO electrode strips and the vertical ITO electrode strips collide with each other and are adjacent to the ITO common electrode 12′, in the dark state, the liquid crystal here is subjected to multiple electric fields, and it is easy to not tilt in the expected direction, resulting in light leakage. The numeral 13′ in FIG. 1 is a black matrix.

### SUMMARY OF THE INVENTION

In order to solve the above technical problem, the present invention provides a liquid crystal display panel, which can improve the contrast of the panel, and does not generate a dark state light leakage at the corners of the pixel electrode.

The present invention provides a liquid crystal display panel comprising: multiple scanning lines and multiple data lines on an array substrate, wherein a top of the data lines is covered with a light-shading electrode line; wherein the multiple scanning lines and the multiple data lines are intersected to define multiple pixel regions, and each pixel region is provided with a pixel electrode; and wherein the pixel electrode is provided with a notch at a corner adjacent to the light-shielding electrode line.

Preferably, light-shading electrode line is extended with a convex pattern at a side of the light-shielding electrode line facing the notch.

Preferably, a black matrix is disposed above the multiple scanning lines.

Preferably, a projection of the black matrix on the array substrate also partially overlapped with the convex pattern of the light-shading electrode line.

Preferably, the pixel electrode includes a pixel electrode frame and two pixel main electrode strips; wherein the pixel electrode frame includes two groups of pixel electrode sides; and each group of pixel electrode side includes two mutually parallel pixel electrode edges, and different groups of pixel electrode sides are perpendicular to each other; in any two adjacent pixel electrode edges, an extension line of a first pixel electrode edge intersects with an extension line of a second pixel electrode edge; each group of pixel electrode sides is connected by one pixel main electrode strip, and the two pixel main electrode strips divide the pixel electrode frame into four pixel electrode strip regions, and each electrode strip region includes multiple pixel sub-electrode strips that are parallel to each other.

Preferably, lengths of the two pixel electrode edges of the same group are the same.

Preferably, the convex pattern on the light-shielding electrode line is a rectangle, and the convex pattern on the light-shielding electrode line is not contacted with the pixel electrode.

Preferably, the panel further includes a common electrode on the color filter substrate; a black matrix located between the array substrate and the common electrode on the color filter substrate; and the convex pattern on the light-shielding electrode line and the pixel electrode are both opposite to the common electrode on the color filter substrate.

Preferably, the light-shading electrode line is an ITO electrode that is connected to a common electric signal.

The present invention also provides a liquid crystal display panel comprising: multiple scanning lines and multiple data lines on an array substrate, wherein a top of the data lines is covered with a light-shading electrode line; wherein the multiple scanning lines and the multiple data lines are intersected to define multiple pixel regions, and each pixel region is provided with a pixel electrode; and wherein the pixel electrode is provided with a notch at a corner adjacent to the light-shielding electrode line; wherein light-shading electrode line is extended with a convex pattern at a side of the light-shielding electrode line facing the notch; wherein the pixel electrode includes a pixel electrode frame and two pixel main electrode strips; wherein the pixel electrode frame includes two groups of pixel electrode sides, and each group of pixel electrode side includes two mutually parallel pixel electrode edges, and different groups of pixel electrode sides are perpendicular to each other; in any two adjacent pixel electrode edges, an extension line of a first pixel electrode edge intersects with an extension line of a second pixel electrode edge; and each group of pixel electrode sides is connected by one pixel main electrode strip, and the two pixel main electrode strips divide the pixel electrode frame into four pixel electrode strip regions, and each electrode strip region includes multiple pixel sub-electrode strips that are parallel to each other.

Preferably, a black matrix is disposed above the multiple scanning lines.

Preferably, a projection of the black matrix on the array substrate also partially overlapped with the convex pattern of the light-shading electrode line.

Preferably, lengths of the two pixel electrode edges of the same group are the same.

Preferably, the convex pattern on the light-shielding electrode line is a rectangle, and the convex pattern on the light-shielding electrode line is not contacted with the pixel electrode.

Preferably, the panel further includes a common electrode on the color filter substrate, a black matrix located between the array substrate and the common electrode on the color filter substrate, and the convex pattern on the light-shielding electrode line and the pixel electrode are both opposite to the common electrode on the color filter substrate.

Preferably, the light-shading electrode line is an ITO electrode that is connected to a common electric signal.

The present invention also provides a liquid crystal display panel comprising: multiple scanning lines and multiple data lines on an array substrate, wherein a top of the data lines is covered with a light-shading electrode line; wherein the multiple scanning lines and the multiple data lines are intersected to define multiple pixel regions, and each pixel region is provided with a pixel electrode; and wherein the pixel electrode is provided with a notch at a corner adjacent to the light-shielding electrode line; wherein light-shading electrode line is extended with a convex pattern at a side of the light-shielding electrode line facing the notch; and wherein the light-shading electrode line is an ITO electrode that is connected to a common electric signal.

Wherein a black matrix is disposed above the multiple scanning lines; wherein a projection of the black matrix on the array substrate also partially overlapped with the convex pattern of the light-shading electrode line; wherein the panel further includes a common electrode on the color filter substrate, a black matrix located between the array substrate and the common electrode on the color filter substrate, and the convex pattern on the light-shielding electrode line and the pixel electrode are both opposite to the common electrode on the color filter substrate.

Wherein the pixel electrode includes a pixel electrode frame and two pixel main electrode strips; wherein the pixel electrode frame includes two groups of pixel electrode sides, and each group of pixel electrode side includes two mutually parallel pixel electrode edges, and different groups of pixel electrode sides are perpendicular to each other; in any two adjacent pixel electrode edges, an extension line of a first pixel electrode edge intersects with an extension line of a second pixel electrode edge; each group of pixel electrode sides is connected by one pixel main electrode strip, and the two pixel main electrode strips divide the pixel electrode frame into four pixel electrode strip regions, and each electrode strip region includes multiple pixel sub-electrode strips that are parallel to each other.

Wherein lengths of the two pixel electrode edges of the same group are the same; wherein the convex pattern on the light-shielding electrode line is a rectangle, and the convex pattern on the light-shielding electrode line is not contacted with the pixel electrode.

The invention has the following beneficial effects: by providing a notch at the corners of the pixel electrode, a conflicting electric field between the corner of the pixel electrode and the common electrode of the color filter substrate opposite thereto can be avoid. At the same time, liquid crystal deflection at and near the corners of the pixel electrode can be avoided. Therefore, the present invention can avoid the situation that the liquid crystal display panel forms light leakage in the dark state at the corners of the pixel electrode, and improves the contrast of the liquid crystal display panel.

### BRIEF DESCRIPTION OF THE DRAWINGS

In order to more clearly illustrate the embodiments of the present invention or the technical solutions in the prior art, the drawings used in the embodiments or the prior art description will be briefly introduced below. Obviously, the drawings in the following description are only some embodiments of the present invention. For those of ordinary skill in the art, without creative labor, other drawings can also be obtained from these figures.

FIG. 1 is a schematic diagram of a pixel structure corresponding to a DBS design viewed from a top view in a background art provided by the present invention.

FIG. 2 is a schematic diagram of the structure of a pixel in a liquid crystal display panel viewed from a top view provided by the present invention.

FIG. 3 is a schematic diagram of a pixel electrode frame provided by the present invention.

FIG. 4 is a schematic diagram of a pixel electrode provided by the present invention.

FIG. 5 is a schematic diagram showing a relative relationship between a pixel electrode, a light-shielding electrode line, a black matrix, and a common electrode of a color filter substrate in the liquid crystal display panel provided by the present invention.

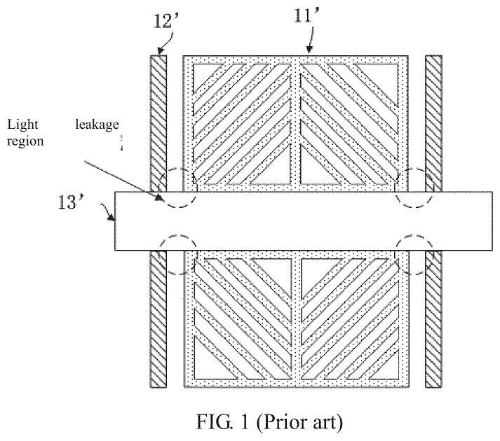

### DETAILED DESCRIPTION OF PREFERRED EMBODIMENTS

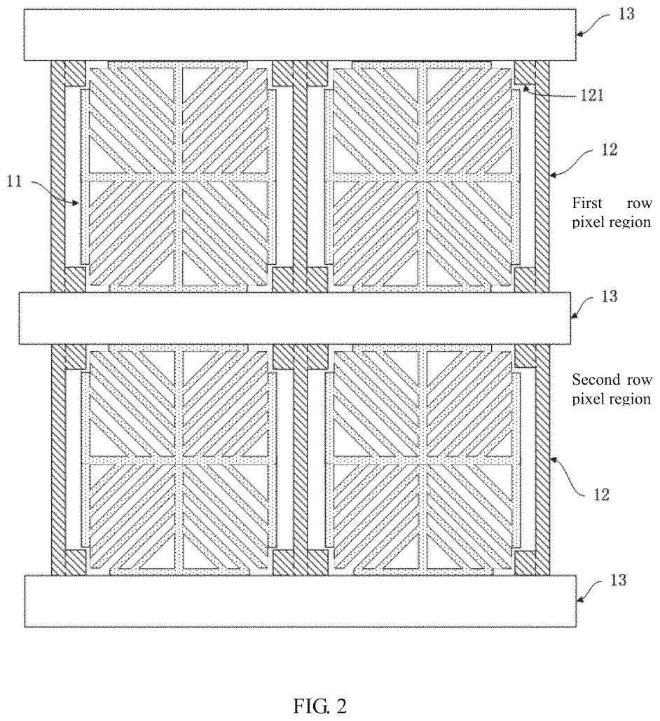

The present invention provides a liquid crystal display panel comprising: multiple scanning lines and multiple data lines on an array substrate, a top of the data lines is covered with a light-shading electrode line 12 as shown in FIG. 2; and the multiple scanning lines and the multiple data lines are intersected to define multiple pixel regions, and each pixel region is provided with a pixel electrode 11; and the pixel electrode 11 is provided with a notch at a corner adjacent to the light-shielding electrode line 12. The light-shading electrode line 12 is extended with a convex pattern 121 at a side of the light-shielding electrode line 12 facing the notch.

A black matrix 13 is disposed above the multiple scanning lines, and the black matrix 13 is used to shield the scanning lines on the array substrate.

The light-shielding electrode line 12 is extended with a convex pattern 121 at a side facing the notch of the pixel electrode 11, and the convex pattern 121 and the light-shielding electrode line 12 are made of a same material.

Here, since the electric field at the corners of the pixel electrode will generate conflict, the electric field formed between the two sides of the pixel electrode and the common electrode of the color filter substrate controls the liquid crystal between the pixel electrode 11 and the common electrode of the color filter substrate to be deflected in different directions, and it is not easy to control the deflection of the liquid crystal at the corners, so that the liquid crystal at the corners may generate a light leakage in the dark state.

Providing a notch at the corner of the pixel electrode 11 can avoid that a conflicting electric field is generated between the pixel electrode 11 and the common electrode of the color filter substrate at the corner of the pixel electrode, and avoid a deflection of the liquid crystal at the corners and neighborhood of the pixel electrode. At the same time, the convex pattern 121 is disposed on the light-shading electrode line 12 facing the notch, and the voltage level of the convex pattern 121 is the same as the voltage level on the common electrode of the color filter substrate, so as to further ensure that the electric field generated at the corner does not control the deflection of the liquid crystal such that the liquid crystal at the corner does not have a light leakage in the dark state.

Furthermore, a projection of the black matrix 13 on the array substrate also partially overlapped with the convex pattern 121 of the light-shading electrode line 12. Here, the array substrate is located below, the black matrix 13 is located above, and the projection of the black matrix 13 on the array substrate also overlapped with the convex pattern 121 of the light-shading electrode line 12, that is, the convex pattern 121 of the light-shading electrode line 12 will extend below the black matrix 13.

Here, extending the convex pattern on the light-shading electrode line 12 below the black matrix 13 can increase the strength and influence range of the common electric field between the light-shading electrode line 12 and the common electrode of the color filter substrate so that it is possible to avoid a situation that the liquid crystal at the edge of the black matrix 13 or the liquid crystal at the corners of the pixel electrode generate a light leakage in the dark state.

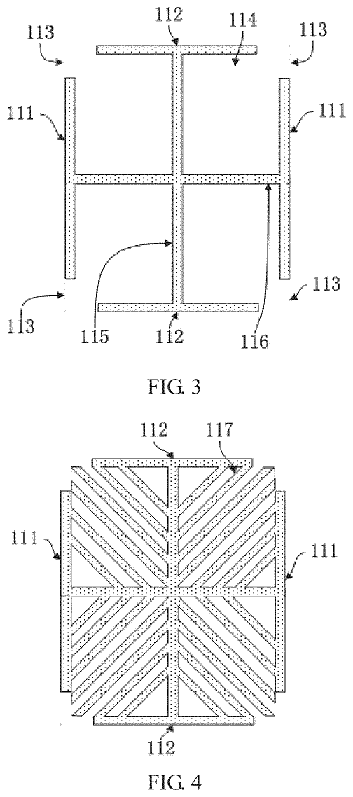

Furthermore, the pixel electrode 11 includes a pixel electrode frame and two pixel main electrode strips 115, 116 as shown in FIG. 3.

Wherein the pixel electrode frame includes two groups of pixel electrode sides, and each group of pixel electrode side includes two mutually parallel pixel electrode edges, and different groups of pixel electrode sides are perpendicular to each other. For example, a first group of pixel electrode sides includes two mutually parallel pixel electrode edges 111, and a second group of pixel electrode sides includes two mutually parallel pixel electrode edges 112, Lengths of the two pixel electrode edges of the same group are the same, for example, the lengths of the two pixel electrode edges 111 are the same, and the lengths of the two pixel electrode edges 112 are also the same.

Furthermore, in any two adjacent pixel electrode edges, an extension line of a first pixel electrode edge intersects with an extension line of a second pixel electrode edge. That is, any adjacent two pixel electrode edges are not directly connected to each other in order to form a notch 113 as shown in FIG. 3, and the notch on the pixel electrode 11 is located on the pixel electrode frame. In this way, electric fields in different directions between a connection location of the adjacent two pixel electrode edges and the common electrode of the color filter substrate can avoid to be formed so as to control the liquid crystal to be deflected in different directions. Accordingly, a situation that the liquid crystal at the corners of the pixel electrode generates a light leakage in a dark status can be avoided.

Each group of pixel electrode sides is connected by one pixel main electrode strip, and the two pixel main electrode strips divide the pixel electrode frame into four pixel electrode strip regions 114. As shown in FIG. 4, each electrode strip region 114 includes multiple pixel sub-electrode strips 117 that are parallel to each other. Preferably, both ends of the pixel main electrode strip are respectively connected to midpoints of the pixel electrode edges, and the four pixel electrode strip regions 114 are same rectangular regions.

Furthermore, the convex pattern 121 on the light-shielding electrode line 12 is a rectangle, and the convex pattern 121 on the light-shielding electrode line 12 is not contacted with the pixel electrode 11. For example, widths of the four pixel electrode edges on the pixel electrode frame are the same, and the width of the convex pattern 121 on the light-shielding electrode line 12 may be set to be the same as the width of the pixel electrode edge. The convex pattern 121 on the light-shading electrode line 12 is controlled not to be contacted with the pixel electrode 11, and the voltage level on the pixel electrode 11 is prevented from being the same as the voltage level on the light-shading electrode line 12 and the voltage level of the common electrode of the color filter substrate, thereby avoiding the liquid crystal between pixel electrode 11 and the common electrode of the color filter substrate is not deflected.

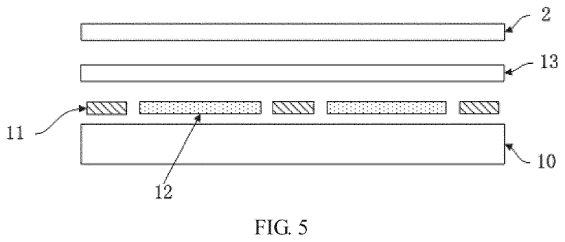

Furthermore, the present invention further includes a common electrode on the color filter substrate, a black matrix 13 located between the array substrate and the common electrode on the color filter substrate, and the convex pattern 121 on the light-shielding electrode line 12 and the pixel electrode 11 are both opposite to the common electrode on the color filter substrate. As shown in FIG. 5, in the direction away from the array substrate 10, the light-shielding electrode line 12, the pixel electrode 11, the black matrix 13, and the common electrode 2 on the color filter substrate are sequentially formed. In general, the liquid crystal is located between the electrode layer of the pixel electrode 11 and the light-shielding electrode line 12 and the common electrode 2 on the color filter substrate.

Furthermore, the light-shading electrode line 12 is an ITO (indium tin oxide) electrode that is connected to a common electric signal, and the pixel electrode 11 may also be an electrode made of ITO. The light-shading electrode line 12 and the pixel electrode 11 may be made of the same layer of ITO.

In summary, the present invention provides a convex pattern 121 on the light-shielding electrode line 12 adjacent to the pixel electrode 11, and in the direction of the notch facing the pixel electrode 11, by providing a notch at the corner of the pixel electrode 11, and the convex pattern is formed. The voltage level on the convex pattern 121 is the same as the voltage level of the common electrode of the color filter substrate, avoiding a conflicting electric field between the corner electrodes of the pixel electrode 11 and the common electrode of the color filter substrate opposite thereto. At the same time, the voltage level between the convex pattern 121 on the light-shading electrode line 12 and the common electrode of the color filter substrate is the same, so as to avoid that the liquid crystal deflects at and near the corners of the pixel electrode. Therefore, the present invention can avoid the situation that the liquid crystal display panel forms light leakage in the dark state at the corners of the pixel electrode 11, and improves the contrast of the liquid crystal display panel corresponding to the pixel structure of the DBS design in the HVA mode.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A liquid crystal display panel comprising:
multiple scanning lines and multiple data lines on an array substrate, wherein a top of the data lines is covered with a light-shading electrode line;
wherein the multiple scanning lines and the multiple data lines are intersected to define multiple pixel regions, and each pixel region is provided with a pixel electrode; and
wherein the pixel electrode is provided with a notch at a corner adjacent to the light-shielding electrode line.

2. The liquid crystal display panel according to claim 1, wherein light-shading electrode line is extended with a convex pattern at a side of the light-shielding electrode line facing the notch.

3. The liquid crystal display panel according to claim 2, wherein a black matrix is disposed above the multiple scanning lines.

4. The liquid crystal display panel according to claim 3, wherein a projection of the black matrix on the array substrate also partially overlapped with the convex pattern of the light-shading electrode line.

5. The liquid crystal display panel according to claim 1, wherein the pixel electrode includes a pixel electrode frame and two pixel main electrode strips;
wherein the pixel electrode frame includes two groups of pixel electrode sides, and each group of pixel electrode side includes two mutually parallel pixel electrode edges, and different groups of pixel electrode sides are perpendicular to each other;
in any two adjacent pixel electrode edges, an extension line of a first pixel electrode edge intersects with an extension line of a second pixel electrode edge;
each group of pixel electrode sides is connected by one pixel main electrode strip, and the two pixel main electrode strips divide the pixel electrode frame into four pixel electrode strip regions, and each electrode strip region includes multiple pixel sub-electrode strips that are parallel to each other.

6. The liquid crystal display panel according to claim 5, wherein lengths of the two pixel electrode edges of the same group are the same.

7. The liquid crystal display panel according to claim 5, wherein the convex pattern on the light-shielding electrode line is a rectangle, and the convex pattern on the light-shielding electrode line is not contacted with the pixel electrode.

8. The liquid crystal display panel according to claim 3, wherein the panel further includes a common electrode on the color filter substrate, a black matrix located between the array substrate and the common electrode on the color filter substrate, and the convex pattern on the light-shielding electrode line and the pixel electrode are both opposite to the common electrode on the color filter substrate.

9. The liquid crystal display panel according to claim 1, wherein the light-shading electrode line is an ITO electrode that is connected to a common electric signal.

10. A liquid crystal display panel comprising:
multiple scanning lines and multiple data lines on an array substrate, wherein a top of the data lines is covered with a light-shading electrode line;
wherein the multiple scanning lines and the multiple data lines are intersected to define multiple pixel regions; and each pixel region is provided with a pixel electrode; and
wherein the pixel electrode is provided with a notch at a corner adjacent to the light-shielding electrode line;
wherein light-shading electrode line is extended with a convex pattern at a side of the light-shielding electrode line facing the notch;
wherein the pixel electrode includes a pixel electrode frame and two pixel main electrode strips;
wherein the pixel electrode frame includes two groups of pixel electrode sides, and each group of pixel electrode side includes two mutually parallel pixel electrode edges, and different groups of pixel electrode sides are perpendicular to each other;
in any two adjacent pixel electrode edges, an extension line of a first pixel electrode edge intersects with an extension line of a second pixel electrode edge; and
each group of pixel electrode sides is connected by one pixel main electrode strip, and the two pixel main electrode strips divide the pixel electrode frame into four pixel electrode strip regions, and each electrode strip region includes multiple pixel sub-electrode strips that are parallel to each other.

11. The liquid crystal display panel according to claim 10, wherein a black matrix is disposed above the multiple scanning lines.

12. The liquid crystal display panel according to claim 11, wherein a projection of the black matrix on the array substrate also partially overlapped with the convex pattern of the light-shading electrode line.

13. The liquid crystal display panel according to claim 10, wherein lengths of the two pixel electrode edges of the same group are the same.

14. The liquid crystal display panel according to claim 10, wherein the convex pattern on the light-shielding electrode line is a rectangle, and the convex pattern on the light-shielding electrode line is not contacted with the pixel electrode.

15. The liquid crystal display panel according to claim 11, wherein the panel further includes a common electrode on the color filter substrate, a black matrix located between the array substrate and the common electrode on the color filter substrate, and the convex pattern on the light-shielding electrode line and the pixel electrode are both opposite to the common electrode on the color filter substrate.

16. The liquid crystal display panel according to claim 10, wherein the light-shading electrode line is an ITO electrode that is connected to a common electric signal.

17. A liquid crystal display panel comprising:
multiple scanning lines and multiple data lines on an array substrate, wherein a top of the data lines is covered with a light-shading electrode line;
wherein the multiple scanning lines and the multiple data lines are intersected to define multiple pixel regions, and each pixel region is provided with a pixel electrode; and
wherein the pixel electrode is provided with a notch at a corner adjacent to the light-shielding electrode line;
wherein light-shading electrode line is extended with a convex pattern at a side of the light-shielding electrode line facing the notch; and
wherein the light-shading electrode line is an ITO electrode that is connected to a common electric signal.

18. The liquid crystal display panel according to claim 17, wherein a black matrix is disposed above the multiple scanning lines;
wherein a projection of the black matrix on the array substrate also partially overlapped with the convex pattern of the light-shading electrode line;
wherein the panel further includes a common electrode on the color filter substrate, a black matrix located between the array substrate and the common electrode on the color filter substrate, and the convex pattern on the light-shielding electrode line and the pixel electrode are both opposite to the common electrode on the color filter substrate.

19. The liquid crystal display panel according to claim 17, wherein the pixel electrode includes a pixel electrode frame and two pixel main electrode strips;
wherein the pixel electrode frame includes two groups of pixel electrode sides, and each group of pixel electrode side includes two mutually parallel pixel electrode edges, and different groups of pixel electrode sides are perpendicular to each other;
in any two adjacent pixel electrode edges, an extension line of a first pixel electrode edge intersects with an extension line of a second pixel electrode edge;
each group of pixel electrode sides is connected by one pixel main electrode strip, and the two pixel main electrode strips divide the pixel electrode frame into four pixel electrode strip regions, and each electrode strip region includes multiple pixel sub-electrode strips that are parallel to each other.

20. The liquid crystal display panel according to claim 19, wherein lengths of the two pixel electrode edges of the same group are the same;
wherein the convex pattern on the light-shielding electrode line is a rectangle, and the convex pattern on the light-shielding electrode line is not contacted with the pixel electrode.
